(19) United States
(12) Patent Application Publication
(10) Pub. No.: US 2014/0249932 A1
(43) Pub. Date: Sep. 4, 2014

(54) SHIPPING LABEL ADVERTISING SYSTEM AND METHOD

(71) Applicant: Boxstar, LLC, Addison, TX (US)

(72) Inventor: Chris Gilliam, Dallas, TX (US)

(73) Assignee: Boxstar, LLC, Addison, TX (US)

(21) Appl. No.: 14/279,018

(22) Filed: May 15, 2014

Related U.S. Application Data
(63) Continuation-in-part of application No. 14/069,319, filed on Oct. 31, 2013.
(60) Provisional application No. 61/795,883, filed on Oct. 31, 2012.

(51) Int. Cl. G06Q 30/02

(52) U.S. Cl. CPC G06Q 30/0251
USPC 705/14.66; 705/14.49

(57) ABSTRACT

A web portal residing on a computer server coupled to a worldwide computer network is configured to receive advertising campaign specifications from an advertiser, including merchandise offerings and customer demographics, identify at least one retailer having characteristics that match the advertising campaign specifications, receive a selection of at least one retailer from the advertiser, receive an advertising image file from the advertiser, receive printer specifications specifying printer and shipping label characteristics from the selected at least one retailer. The web portal is further configured to transmit the advertising image file to a printing vendor to pre-print the advertising image onto a plurality of blank shipping labels that satisfy the printer specifications, the plurality of pre-printed shipping labels to be supplied to the retailer for printing shipping information and application to shipping containers containing outgoing merchandise.

### RELATED APPLICATIONS

The present application is a continuation-in-part application of U.S. Non-Provisional application, Ser. No. 14/069,319, filed on Oct. 31, 2013 and entitled “Mailing Label Advertising System,” which claims benefit of U.S. Provisional Application, Ser. No. 61/795,883, filed on Oct. 31, 2012. Both applications are incorporated herein by reference in their entirety.

### FIELD

The present disclosure primarily relates to a novel shipping label advertising system and method.

### BACKGROUND

Throughout the world online purchases have grown exponentially. Online shoppers in the United States will spend $327 billion in 2016, up 45% from $226 billion this year and 62% from $202 billion in 2011, according to a projection by Forrester Research Inc. In 2016, e-retail will account for 9% of total retail sales, up from 7% in both 2012 and 2011, according to the report, “U.S. Online Retail Forecast.” That represents a compound annual growth rate of over 10% over the five-year forecast period 2011-2016. Another study estimates that web sales in 2013 for Wal-Mart and Amazon were in the range of $10 billion to over $67 billion respectively.

Aside from digital music and software that can be downloaded immediately at the time of purchase, the merchandise orders must be packaged and delivered to the purchasers. Statistics for the 2013 holidays indicate that UPS picked up 32 million packages for delivery on Cyber Monday alone, while FedEx picked up 22 million packages on the same day. The United States Postal Service estimated that it delivered 420 million packages during the 2013 holiday season. Online sales deliveries account for a large percentage of these packages. Therefore, the total number of e-commerce packages delivered to consumers is astonishing.

### DESCRIPTION OF THE DRAWINGS

The present disclosure describes various embodiments illustrated in the drawing figures in which like reference numerals refer to like parts throughout the various views unless otherwise specified.

FIG. 1 is a flow diagram of an exemplary embodiment of a novel shipping label advertising system and method according to the teachings of the present disclosure;

FIG. 2 is an illustration of an exemplary shipping label advertisement of the novel shipping label advertising system and method according to the teachings of the present disclosure;

FIG. 3 is an illustration of another exemplary shipping label advertisement of the novel shipping label advertising system and method according to the teachings of the present disclosure;

FIG. 4 is an illustration of yet another exemplary shipping label advertisement of the novel shipping label advertising system and method according to the teachings of the present disclosure;

FIG. 5 is an illustration of an exemplary shipping label advertisement of the novel shipping label advertising system and method according to the teachings of the present disclosure;

FIG. 6 is an illustration of an exemplary pre-printed shipping label advertisement of the novel shipping label advertising system and method according to the teachings of the present disclosure;

FIG. 7 is an illustration of an exemplary shipping label advertisement of the novel shipping label advertising system and method according to the teachings of the present disclosure;

FIG. 8 is a block diagram of an exemplary embodiment of a novel shipping label advertising system and method according to the teachings of the present disclosure;

FIG. 9 is a flowchart of an exemplary embodiment of an advertising campaign setup process of a novel shipping label advertising system and method according to the teachings of the present disclosure; and

FIG. 10 is a flowchart of an exemplary embodiment of a novel shipping label advertising method according to the teachings of the present disclosure.

### DETAILED DESCRIPTION

The present disclosure describes a novel shipping label advertising system and method that take advantage of the astonishing number of store-to-door packages delivered to the consumer. The system and method enable an advertisement owner to put its print advertisement on a shipping label to reach specific targeted segments of the consumer public. The system and method described herein enable advertisers to “piggyback” custom, process-color advertisements on the tops of outgoing products recently purchased by e-retail customers.

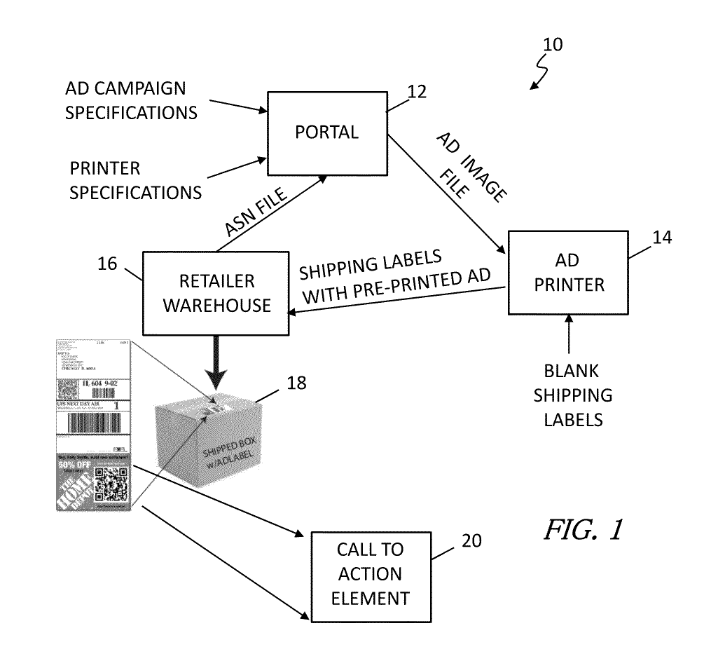

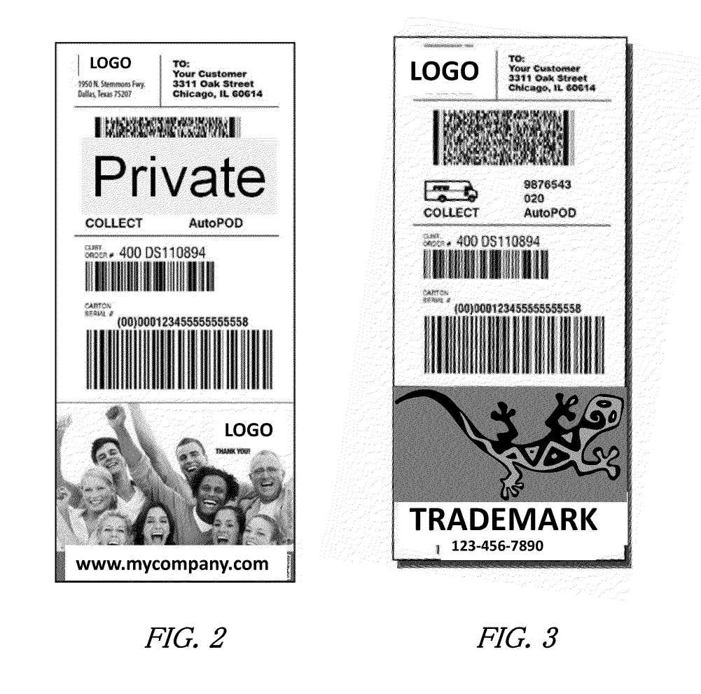

FIG. 1 is a flow diagram of an exemplary embodiment of a novel shipping label advertising system and method 10 according to the teachings of the present disclosure. A web portal 12 provides an interface easily accessible to firms, companies, and other entities who are interested in launching an advertising campaign. The advertisement owner may enter specification of an advertising campaign via the web portal 12. The advertising campaign specifications are parameters and requirements that a desired retailer and its merchandise and customers should satisfy. A retailer is a company or another entity that ships packages containing merchandise to its customers in response to orders placed online, over the telephone, or by another method. An advertising campaign may involve two or more different retailers that combine shipments in order for an advertiser to reach certain customers, or it may be the same retailer presenting advertisements or a special message to its own customers who just made a purchase. The retailer has one or more distribution warehouse facilities that are tasked with the responsibility of picking the order, placing the merchandise in shipping boxes, envelopes, or other shipping containers, placing the shipping labels containing the customers' addresses on the containers, and providing the containers to a carrier or shipping company to deliver them. By providing advertising campaign specifications, the advertisement owner has the ability to define, control, and reach specific target customers who will see its advertisement.

The novel shipping label advertising system and method may comprise predetermined advertising channels that target specific segments of the consumer public. For example, a women's network may include retailers whose primary customer base consists of women, a men's network may include retailers whose primary customer base consists of men, a book of the month club network may include retailers whose primary customer base consists of affluent and more mature women, etc. The advertisement owner may select one or more of these advertising channels to target specific customers.

Retailers are highly incentivized to join the program. A retailer who is selected to participate in an advertising campaign receives the labels containing the advertisements free of charge, and receives financial compensation for the access to its customers made possible by the advertisement on the shipping labels placed on packages sent to its customers. The retailers may be compensated at a per box rate, per campaign rate, or per advertising channel rate, for example. Given the advertising campaign specifications, the shipping label advertising system and method identify those retailers that fit within the parameters of the campaign specifications. One or more candidate retailers are selected and presented to the advertisement owner for selection for the campaign.

The advertisement owner also uploads one or more image files that compose the print advertisement. The file format may be in any format usable by the printer 14 used to print the advertisement image onto blank shipping labels. At the web portal 12, the retailer may enter parameters about its label printers and the types of shipping labels the printers can handle so that the proper blank labels are used when the labels are pre-printed. The shipping labels pre-printed with advertisement are then provided to the retailer's warehouse or distribution facility 16. The retailer prints its customers' shipping information onto the pre-printed labels, and applies the completed shipping labels to the packages 18. These packages are delivered by a carrier to the targeted customers. The retailer then returns an Advance Ship Notice (ASN) file as confirmation that shipment according to the advertising campaign has occurred. The ASN file may include information such as city, state, tracking number, and ship date of packages delivered to the customers.

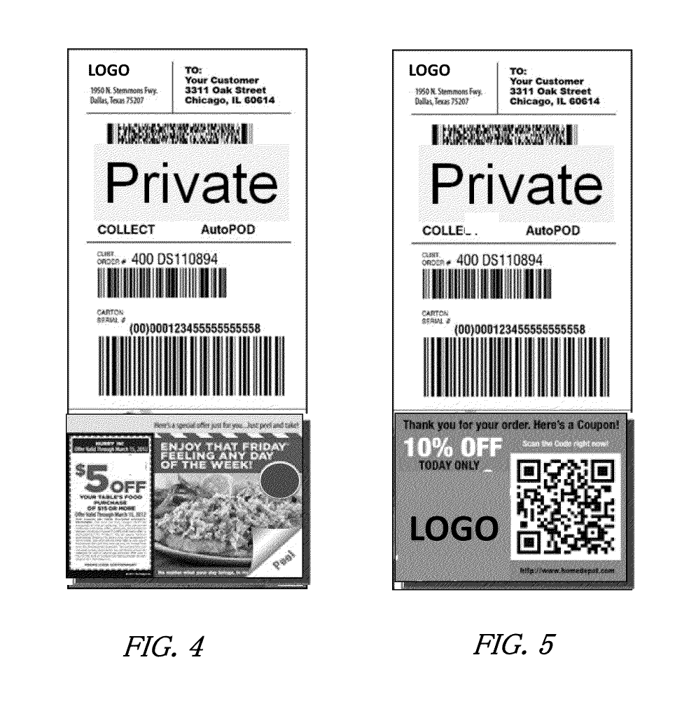

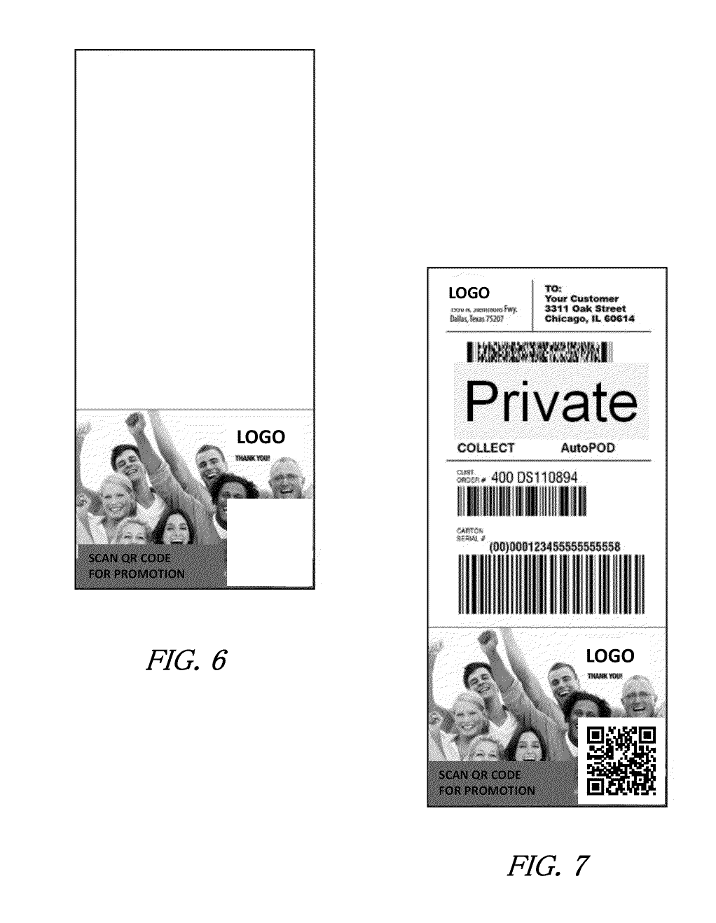

When a customer receives the packages, it bears a shipping label that comprises an eye-catching colorful and high-quality advertisement that is placed in a prominent spot on the package. The advertisement may include many elements of print advertisement: artwork, title or headline, ad copy, and advertiser logo and/or trademark. Additionally, the advertisement may include a “call to action” element 20 that is designed to encourage the customer to act on the advertisement. For example, the call to action element 20 may include a URL (Uniform Resource Locator) that points to a promotional, informational, or social media website or micro-site (an example shown in FIG. 3), a telephone number (an example shown in FIG. 4), a promotional code, a peel-away printed coupon (an example shown in FIG. 5), etc. The advertisement call to action element 20 may include a barcode, QR (Quick Response) code, or another machine-readable code that the customer may scan using a smartphone or another device that would lead to a promotional or informational web page, micro-site, or deliver a mobile coupon. The call to action element 20 may include a coupon QR code that enables a discount (an example shown in FIG. 6), buy one get one free offer, or a deal-of-day when purchases are made, for example. A dynamic discount, promotion, or personalized message can be enabled when it is not specified in the printed advertisement, but becomes apparent when the customer scans the machine-readable code, or the image of the advertisement utilizing AR (Augmented Reality). It is conceivable that the machine-readable code scan combined with some other data that can be gleaned from the customer's smartphone, such as location (e.g., GPS) information, can be used to generate the dynamic promotion, for example. In this way, a promotion or personalized message can be dynamically initiated, changed, tracked, and targeted to certain customers. For example, using the location information, the customer may be directed to a special promotion at the closest store location.

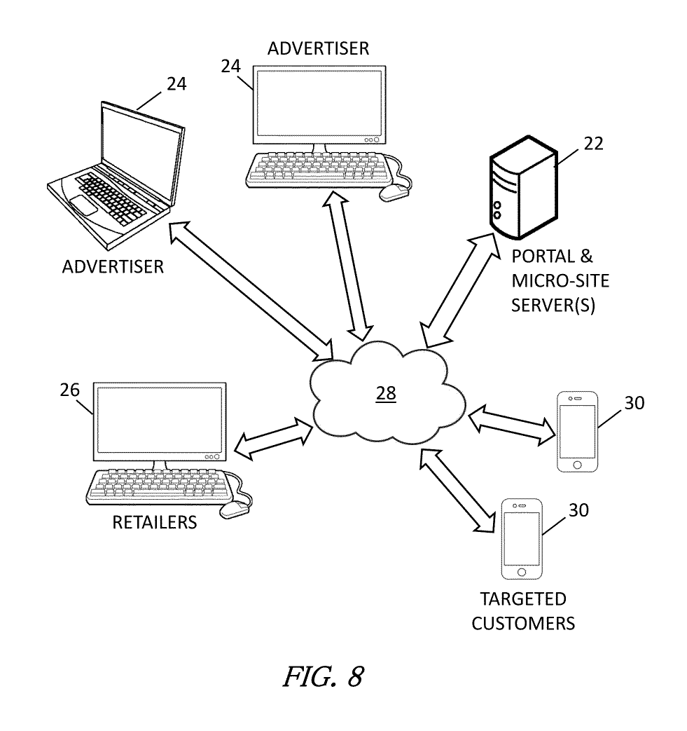

In an alternate embodiment, the advertisement image file may leave a predetermined area in the advertisement image blank, an example of which is shown in FIG. 7. The blank space can then be printed at the time the shipping information is printed with data that dynamically target a particular customer profile or a call to action element 20 that can be varied or more dynamically determined. An example of a completed shipping label with blank space filled in with a QR code is shown in FIG. 8.

In another embodiment, the pre-printed label may include an embedded antenna, such as a printed antenna or microstrip antenna that enables wireless communication between an electronic chip or other device embedded in the shipping label and an electronic computing device such as a smartphone. For example, near field communication (NFC) may be implemented in this manner to enable the smartphone to receive or access promotional information or other types of call to action information. Similarly, RFID (Radio Frequency Identification) technology may be deployed in like manner.

Depending on the conveyor line configuration of the retailer's warehouse, further refinement in the targeted customers may be possible. For example, if a retailer has conveyor lines devoted to particular merchandise categories, even more focused pre-printed advertisement shipping labels may be used for those lines different from labels used in other conveyor lines.

FIG. 8 is a block diagram of an exemplary operating environment of a novel shipping label advertising system and method according to the teachings of the present disclosure. One or more computer servers 22 host the web portal 12 and advertiser micro-sites. The advertisers 24 and retailers 26 may access the web portal 12 to provide the advertising campaign specifications and printer specifications via a worldwide computer network 28 such as the Internet and World Wide Web. Customers targeted by the advertising campaigns can access the micro-sites using smartphones 30 or other electronic devices via the call to action elements 20 printed as part of the advertisement on the shipping label.

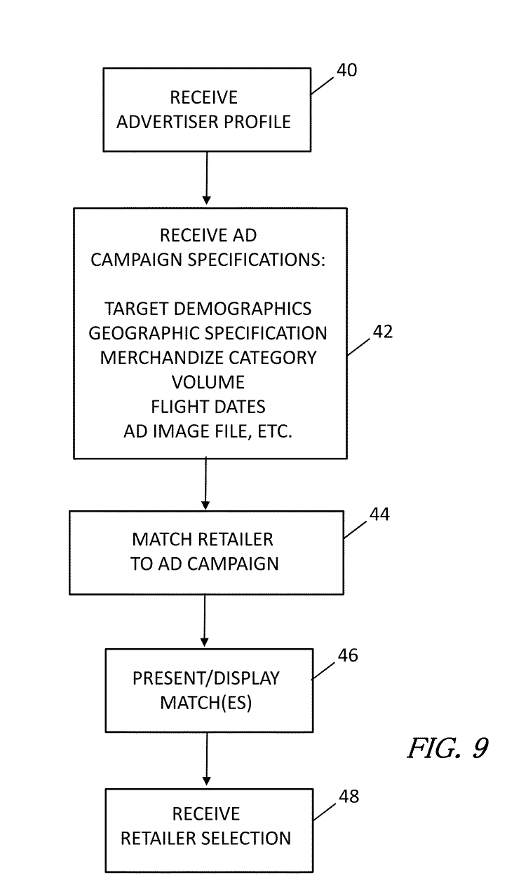

FIG. 9 is a flowchart of an exemplary embodiment of an advertising campaign setup process of a novel shipping label advertising system and method according to the teachings of the present disclosure. In block 40, the advertiser's information is supplied, preferably via the web portal 12, to the system. The advertiser profile information may include company name, contact persons' names, address, telephone number, shipping address, email address, etc. In block 42, the advertiser provides the advertising campaign specifications. The advertising campaign specifications include the targeted customer demographic information. The demographic information may include an indication or selection of target merchandise category (e.g., automotive parts/accessories, sporting goods, books, music, health/beauty, jewelry, toys/hobbies, food, drugs, housewares, home furnishing, flowers, candies/gifts, electronics/games, office supplies, etc.), household income, target geographic region, ethnicity, gender, age range, and other characteristics. The advertisement owner may further enter a name for the advertising campaign to distinguish it from others, the campaign volume (i.e., the number of boxes), and the campaign start date and end date (also called flight dates). The advertiser further uploads one or more advertising message files for the advertisement to be pre-printed or otherwise prepare the shipping labels.

In block 44, the system and method identify one or more retailers that satisfy the advertisement campaign specifications, as well as availability of the retailer(s) shipments for advertising. For example, a particular retailer that specializes in certain electronic equipment and computer games may match the advertising campaign if the advertisement targets young male consumers, and have shipping containers available for advertising during specific flight dates. One or more matches are made and displayed, as shown in block 46, and the advertisement owner may select one or more retailer from among the matched retailers to carry out the campaign, as shown in block 48. In this manner, an advertising campaign is ready to be launched on the start date.

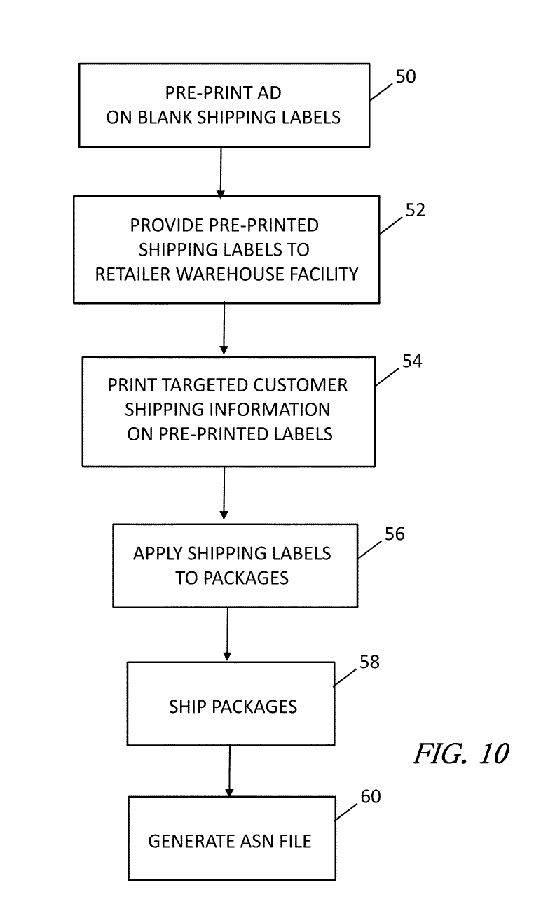

FIG. 10 is a flowchart of an exemplary embodiment of a novel shipping label advertising method according to the teachings of the present disclosure. In block 50, the image file is used to pre-print the advertisement on blank labels. The retailer specifies the labels' dimensions, adhesive type, orientation, type (in roll, fanfold, sheet feed, or other formats), and other characteristics. Therefore, the retailer's processes do not need to be altered or modified in order to participate in the advertising campaign. It may continue to use its printers and type of labels as before. In block 52, the shipping labels pre-printed with the advertisement image are sent to the retailer warehouse facility. In block 54, the customer shipping information is printed on the pre-printed shipping labels. As described above, some selected portions of the advertisement may also be printed at this time. For example, a call to action element 20 such as a QR code may be printed in a space previously left blank on the pre-printed label. In block 56, the shipping labels are then applied to the boxes containing the merchandise. The packages are then provided to a carrier for shipping and delivery to the customers, as shown in block 58. In block 60, a shipment confirmation in the form of an ASN file is generated and provided to the advertisement campaign owner. The ASN is designed to provide confirmation of shipments to the advertiser.

Operating in this manner, a retailer may up-sell or cross-sell to promote its own merchandise offerings to its customers, or be compensated by an advertisement owner for offering advertisement space on shipping labels applied to packages sent to its customers. The advertising campaign can be highly selective to reach the targeted consumer demographic. Print advertisement delivered in this format does not compete with other advertising and is presented in a prominent and visually-engaging manner on the package that the consumer must handle personally. According to the method described herein, the retailer is not required to alter its handling of the packages, such as requiring applying an additional advertising label or sticker to the packages. The system and method may generate and provide the advertisement owner information about the customers that were targeted and confirmation that the delivery occurred during specified time periods. This form of shipping label advertisement can be coordinated with other forms of advertising campaigns to ensure the promotional message reaches the desired consumers. Further, call to action features on the shipping labels can be used to solicit action that can result in further affirmation including the ability to track message delivery.

The term “advertisement” is used herein to mean any type of targeted message that can be embodied on or in the shipping label. Examples of advertisement include text, graphics, illustrations, and photographs. The shipping labels also includes call to action elements that may include telephone numbers, URL, machine-readable code, printed antennas, etc. The targeted message may even stimulate other senses, such as an olfactory one. For example, the shipping label may be impregnated with certain solution to give off a pleasant smell or a smell that is associated with a certain merchandise (roses, chocolate, vanilla, pine, etc.) or entity. Further, it is contemplated that future technology may permit embedding micro-circuitry in the shipping label that is configured to generate messages that stimulates one or more senses in the recipient of the package that can be triggered by location (via GPS technology, for example). Therefore, the message conveyed by the special shipping labels may be any visual, audible, and/or olfactory message that is not part of the shipping information. Indeed, the shape of the shipping label itself may mimic certain logos that is designed to convey a certain advertising message.

The features of the present invention which are believed to be novel are set forth below with particularity in the appended claims. However, modifications, variations, and changes to the exemplary embodiments described above will be apparent to those skilled in the art, and the novel shipping label advertising system and method described herein thus encompasses such modifications, variations, and changes and are not limited to the specific embodiments described herein.

What is claimed is:

1. An advertising shipping label method comprises:
receiving advertising campaign specifications from an advertiser;
identifying at least one retailer having characteristics that match the advertising campaign specifications;
receiving an advertising image file;
receiving printer specifications from the at least one retailer;
having a plurality of shipping labels pre-printed with advertisement from the advertising image file and consistent with the printer specifications;
printing shipping information on the pre-printed shipping labels; and
applying the printed shipping labels to shipping containers.

2. The method of claim 1, further comprising identifying retailer's merchandise orders that match the advertising campaign specifications, and applying the printed shipping labels to shipping containers containing the matching merchandise orders.

3. The method of claim 1, further comprising generating shipping confirmation information to be supplied to the advertiser.

4. The method of claim 1, wherein receiving advertising campaign specification from an advertiser comprising receiving targeted customer demographic information.

5. The method of claim 1, wherein receiving advertising campaign specification from an advertiser comprising receiving a merchandise category.

6. The method of claim 1, wherein receiving advertising campaign specification from an advertiser comprising receiving an advertising channel.

7. The method of claim 1, wherein receiving an advertising image file comprising receiving a call to action feature.

8. The method of claim 6, wherein receiving a call to action feature comprises receiving a machine-readable code pointing to web-based information.

9. The method of claim 1, wherein receiving an advertising image file comprises receiving a call to action feature selected from the group consisting of a telephone number, an URL, a barcode, a QR code, a coupon, and a printed antenna.

10. The method of claim 1, wherein receiving an advertising image file comprises receiving an advertisement configured to accommodate a dynamic element to be printed concurrently with printing the shipping information on the pre-printed shipping label.

11. The method of claim 1, wherein receiving an advertising image file comprises receiving an advertisement configured to accommodate a dynamic personalized message be printed concurrently with printing the shipping information on the pre-printed shipping label.

12. The method of claim 1, wherein receiving advertising campaign specifications comprises receiving targeted customer demographic information selected from the group consisting of: age range, ethnicity, household income, gender, and merchandise category.

13. The method of claim 1, wherein receiving advertising campaign specifications comprises receiving a targeted customer demographic information, campaign volume, campaign start date, and campaign end date.

14. The method of claim 1, wherein receiving printer specifications comprises receiving printer characteristics and shipping label characteristics.

15. The method of claim 1, wherein generating shipping confirmation comprises generating ASN file to be supplied to the advertiser.

16. The method of claim 1, wherein having a plurality of shipping labels pre-printed with advertisement comprises pre-printing the plurality of shipping labels with process color advertisement.

17. A web portal residing on a computer server coupled to a worldwide computer network configured to:
receive advertising campaign specifications from an advertiser, including merchandise offerings and customer demographics;
identify at least one retailer having characteristics that match the advertising campaign specifications;
receive a selection of at least one retailer from the advertiser;
receive an advertising image file from the advertiser;
receive printer specifications specifying printer and shipping label characteristics from the selected at least one retailer; and
transmit the advertising image file to a printing vendor to pre-print the advertising image onto a plurality of blank shipping labels that satisfy the printer specifications, the plurality of pre-printed shipping labels to be supplied to the retailer for printing shipping information and application to shipping containers containing outgoing merchandise.

18. The web portal of claim 17, wherein the web portal is further configured to receive shipping confirmation information from the retailer to be supplied to the advertiser.

19. The web portal of claim 17, wherein the web portal is further configured to receive an advertising campaign channel from an advertiser.

20. The web portal of claim 17, wherein the web portal is further configured to receive an advertising image file comprising a call to action feature.

21. The web portal of claim 17, wherein the web portal is further configured to receive an advertising image file comprising a call to action feature including a machine-readable code pointing to web-based information.

22. The web portal of claim 17, wherein the web portal is further configured to receive a call to action feature selected from the group consisting of a telephone number, an URL, a barcode, a QR code, and a printed antenna.

23. The web portal of claim 17, wherein the web portal is further configured to receive targeted customer demographic information selected from the group consisting of: age range, ethnicity, household income, gender, and merchandise category.

24. The web portal of claim 17, wherein the web portal is further configured to receive a targeted customer demographic information, campaign volume, campaign start date, and campaign end date.

25. An advertising shipping label method comprises:
receiving advertising campaign specifications from an advertiser, including merchandise offerings and customer demographics;
identifying at least one retailer having characteristics that match the advertising campaign specifications;
receive a selection of at least one retailer from the advertiser;
receiving an advertising message from the advertiser;
receiving printer specifications specifying printer and shipping label characteristics from the selected at least one retailer; and
transmitting the advertising message to a vendor to prepare the shipping labels that satisfy the printer specifications, the plurality of prepared shipping labels to be supplied to the retailer for printing shipping information and application to shipping containers containing outgoing merchandise.

26. The method of claim 25, further comprising:
pre-printing a plurality of shipping labels consistent with the printer specifications with advertisement from an advertising image file;
identifying retailer's merchandise orders that match the advertising campaign specifications;
printing shipping information on the pre-printed shipping labels; and
applying the printed shipping labels to shipping containers containing the matching merchandise orders.

27. The method of claim 25, wherein transmitting the advertising message to a vendor to prepare the shipping labels comprises transmitting an audible advertising message.

28. The method of claim 25, further comprising generating shipping confirmation information to be supplied to the advertiser.

29. The method of claim 25, wherein receiving advertising campaign specification from an advertiser comprising receiving an advertising channel.

30. The method of claim 25, wherein receiving an advertising image file comprising receiving a call to action feature.

31. The method of claim 30, wherein receiving a call to action feature comprises receiving a machine-readable code pointing to web-based information.

32. The method of claim 25, wherein receiving an advertising image file comprising receiving a call to action feature selected from the group consisting of a telephone number, an URL, a barcode, a QR code, and a printed antenna.

33. The method of claim 25, wherein receiving advertising campaign specifications comprises receiving targeted customer demographic information selected from the group consisting of: age range, ethnicity, household income, gender, and merchandise category.

34. The method of claim 25, wherein receiving advertising campaign specifications comprises receiving a targeted customer demographic information, campaign volume, campaign start date, and campaign end date.

35. The method of claim 25, wherein receiving printer specifications comprises receiving printer characteristics and shipping label characteristics.
